(19) United States
(12) Patent Application Publication
(10) Pub. No.: US 2026/0014948 A1
(43) Pub. Date: Jan. 15, 2026

(54) BUMPER ASSEMBLY

(71) Applicant: UACJ CORPORATION, Tokyo (JP)

(72) Inventors: Akihiro KOJIMA, Tokyo (JP); Shinji EGUCHI, Tokyo (JP)

(73) Assignee: UACJ CORPORATION, Tokyo (JP)

(21) Appl. No.: 18/844,759

(22) PCT Filed: Mar. 3, 2023
(86) PCT No.: PCT/JP2023/008086

§ 371 Date: Mar. 17, 2025

(30) Foreign Application Priority Data
Mar. 9, 2022 (JP) 2022-036593

(51) Int. Cl. B60R 19/34; B60R 19/18

(52) U.S. Cl. CPC B60R 19/34; B60R 19/18

(57) ABSTRACT

A bumper assembly (100A) comprises: a beam (10) that extends in the vehicle width direction of a vehicle in a state of being attached to the vehicle; an energy absorbing member (20) that is joined to the back surface of the beam; and a load transfer member (30A) that is located between the energy absorbing member (20) and a location on the beam (10) at which a barrier collides in a small overlap test (SOT), and that is joined to the back surface of the beam so as to overlap with the energy absorbing member at least partially in the vehicle width direction.

### TECHNICAL FIELD

The present invention relates to a bumper assembly to be located on a front portion of a vehicle.

### BACKGROUND ART

Recently, a small overlap test (SOT) has been introduced as a type of offset frontal collision test to improve the safety performance of vehicles. The SOT was carried out and made public at the end of 2012 by IIHS (Insurance Institute for Highway Safety) of the U.S.A. The SOT is a partial collision test by which a portion of 25% (¼) of a front surface of a vehicle on the driver's seat side is caused to collide against a collision barrier (hereinafter, referred to as a “barrier”) at 40 mph (about 64 kph).

In order to improve the safety performance in the small overlap test, Patent Document No. 1, for example, discloses a configuration of an end portion of a vehicle body, the configuration including a pair of frame members located symmetrically to each other while having a power unit therebetween, a bumper frame portion connected to tips of the pair of frame members, and spacer members respectively protruding from extending portions of the bumper frame portion toward the frame members. The frame members each include a front side member and a crash box (also referred to as an “energy absorption member” or a “stay”) provided at a front end of the front side member. Each of the spacer members (slide spacers) is located between the corresponding extending portion of the bumper reinforcement (also referred to as a “beam”) and the corresponding frame member, and acts as a load transmission member converting a rearward load input to the extending portion into an inward load in a vehicle width direction and transmitting the inward load to the front end or the vicinity thereof of the front side member (see, for example, FIG. 1 of Patent Document No. 1).

### CITATION LIST

### Patent Literature

Patent Document No. 1; Japanese Laid-Open Patent Publication No. 2014-113894 (Japanese Patent No. 5880417)

### SUMMARY OF INVENTION

### Technical Problem

However, according to studies made by the present inventors, the configuration of Patent Document No. 1 does not necessarily allow the spacer members to transmit a collision load caused in the small overlap test to a frame structure of the vehicle body sufficiently effectively, and has room for improvement.

Thus, the present invention has an object of providing a bumper assembly including a load transmission member capable of transmitting a collision load caused in a small overlap test to a frame structure of a vehicle body more effectively.

### Solution to Problem

Embodiments of the present invention provide the solutions described in the following items.

### [Item 1]

A bumper assembly attachable to a front portion of a vehicle, the bumper assembly comprising, in a state of being attached to the vehicle:
a beam extending in a vehicle width direction;
an energy absorption member joined with a rear surface of the beam; and
a load transmission member located between a position, in the beam, against which a barrier is to collide in an SOT (small overlap test) and the energy absorption member, and joined with the rear surface of the beam so as to overlap at least a portion of the energy absorption member in the vehicle width direction.

### [Item 2]

The bumper assembly of item 1, wherein in a state of being attached to the vehicle, the load transmission member comprises:
a plate-like portion extending along the beam in a cross-section parallel to a horizontal plane and including a flat plate portion overlapping at least a portion of the energy absorption member in the vehicle width direction, and
a protrusion portion protruding from the plate-like portion into a space between the rear surface of the beam and the energy absorption member.

### [Item 3]

The bumper assembly of item 2, further comprising a plate to be joined with a frame of the vehicle, wherein:
the energy absorption member is joined with the plate,
the plate comprises a peripheral portion extending in the vehicle width direction beyond the energy absorption member, and
in a state of being attached to the vehicle, the protrusion portion of the load transmission member is located in a space defined by the rear surface of the beam, the energy absorption member and a plane extending from the plate, in a cross-section parallel to the horizontal plane.

### [Item 4]

The bumper assembly of item 3, wherein the protrusion portion comprises a first portion contacting the peripheral portion of the plate in the SOT.

### [Item 5]

The bumper assembly of item 4, wherein the protrusion portion comprises a second portion contacting, in the SOT, a side surface of the energy absorption member, the side surface being perpendicular to the plate.

### [Item 6]

The bumper assembly of item 5, wherein the protrusion portion comprises a third portion that, in the SOT, becomes generally parallel to a line connecting the position, in the beam, against which the barrier is to collide and an intersection of the plate and the side surface of the energy absorption member, the third portion becoming generally parallel to the line in the cross-section parallel to the horizontal plane.

### [Item 7]

The bumper assembly of any one of items 2 through 6, wherein:
the rear surface of the beam has a recessed portion, and
the plate-like portion of the load transmission member is fitted into the recessed portion.

### [Item 8]

The bumper assembly of any one of items 1 through 7, wherein the energy absorption member comprises a plurality of cylindrical portions extending in a front-rear direction of the vehicle.

### Advantageous Effects of Invention

Embodiments of the present invention provide a bumper assembly capable of transmitting a collision load caused in a small overlap test to a frame structure of a vehicle body more effectively.

### BRIEF DESCRIPTION OF DRAWINGS

FIG. 1 is a schematic plan view showing the positional relationship between a barrier BR and a bumper assembly 100 according to an embodiment of the present invention in a small overlap test (SOT).

FIG. 2 is a schematic exploded perspective view of a bumper assembly 100A according to an embodiment of the present invention.

FIG. 3A is a schematic rear view of the bumper assembly 100A.

FIG. 3B is a schematic cross-sectional view of the bumper assembly 100A taken along line 3B-3B′ in FIG. 3A.

FIG. 3C is a schematic cross-sectional view of the bumper assembly 100A taken along line 3C-3C′ in FIG. 3A.

FIG. 4A is a schematic plan view showing the positional relationship between the barrier BR and the bumper assembly 100A at the instance of collision in the SOT.

FIG. 4B is a schematic plan view showing a shape of the bumper assembly 100A during the collision (early period) in the SOT.

FIG. 4C is a schematic plan view showing a shape of the bumper assembly 100A during the collision (early middle period) in the SOT.

FIG. 4D is a schematic plan view showing a shape of the bumper assembly 100A during the collision (late middle period) in the SOT.

FIG. 4E is a schematic plan view showing a shape of the bumper assembly 100A during the collision (late period) in the SOT.

FIG. 5A is a schematic plan view showing the positional relationship between the barrier BR and a bumper assembly 200 in a comparative example at the instance of collision in the SOT.

FIG. 5B is a schematic plan view showing a shape of the bumper assembly 200 during the collision (early period) in the SOT.

FIG. 5C is a schematic plan view showing a shape of the bumper assembly 200 during the collision (early middle period) in the SOT.

FIG. 5D is a schematic plan view showing a shape of the bumper assembly 200 during the collision (late middle period) in the SOT.

FIG. 5E is a schematic plan view showing a shape of the bumper assembly 200 during the collision (late period) in the SOT.

FIG. 6 load-stroke diagram showing the load transmitted by the bumper assembly to a frame structure of a vehicle body in the SOT.

FIG. 7A is a schematic cross-sectional view of another bumper assembly 100B according to an embodiment of the present invention.

FIG. 7B is a schematic cross-sectional view of still another bumper assembly 100C according to an embodiment of the present invention.

FIG. 7C is a schematic cross-sectional view of still another bumper assembly 100D according to an embodiment of the present invention.

### DESCRIPTION OF EMBODIMENTS

Hereinafter, a bumper assembly according to an embodiment of the present invention will be described with reference to the drawings. The bumper assembly according to an embodiment of the present invention is not limited to the one described below as an example.

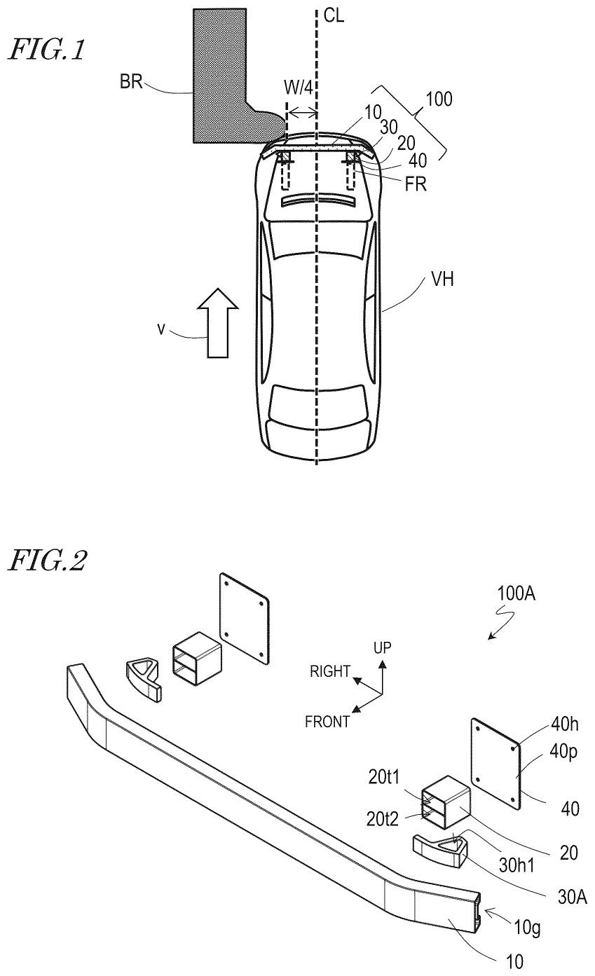

FIG. 1 is a schematic plan view showing the positional relationship between a barrier BR and a bumper assembly 100 according to an embodiment of the present invention in a small overlap test (SOT). In this embodiment, a common passenger car (left-hand drive) is shown as an example of vehicle VH. As shown in FIG. 1, in the SOT, a portion of a front surface of the vehicle VH that is offset by W/4 from the center CL of a vehicle width W is caused to collide against the barrier BR at a velocity v of 40 mph (about 64 kph).

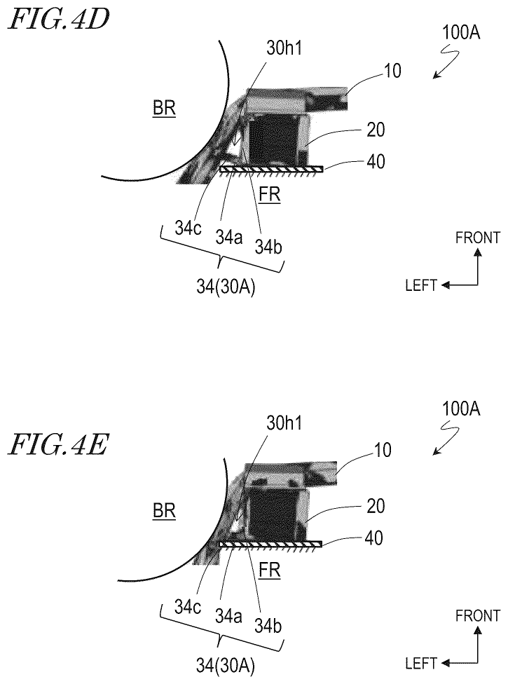

The bumper assembly 100 according to an embodiment of the present invention is attached to a front portion of the vehicle VH. In a state of being attached to the vehicle VH, the bumper assembly 100 includes a beam 10 extending in a vehicle width direction of the vehicle VH, an energy absorption member (stay) 20 joined with a rear surface of the beam 10, and a load transmission member 30 located between a position, in the beam 10, against which the barrier BR is to collide in the SOT (see, for example, point PS in FIG. 4A) and the energy absorption member 20 and joined with the rear surface of the beam 10 so as to overlap at least a portion of the energy absorption member 20 in the vehicle width direction. The bumper assembly 100 further includes a plate 40 to be joined with a frame FR of the vehicle VH, and the energy absorption member 20 is joined with the plate 40. The plate 40 may be omitted, in which case the energy absorption member 20 may be directly joined with the frame FR. In this case, the frame FR may have a portion extending in the vehicle width direction beyond the energy absorption member 20. The frame FR is included in a frame structure of a vehicle body.

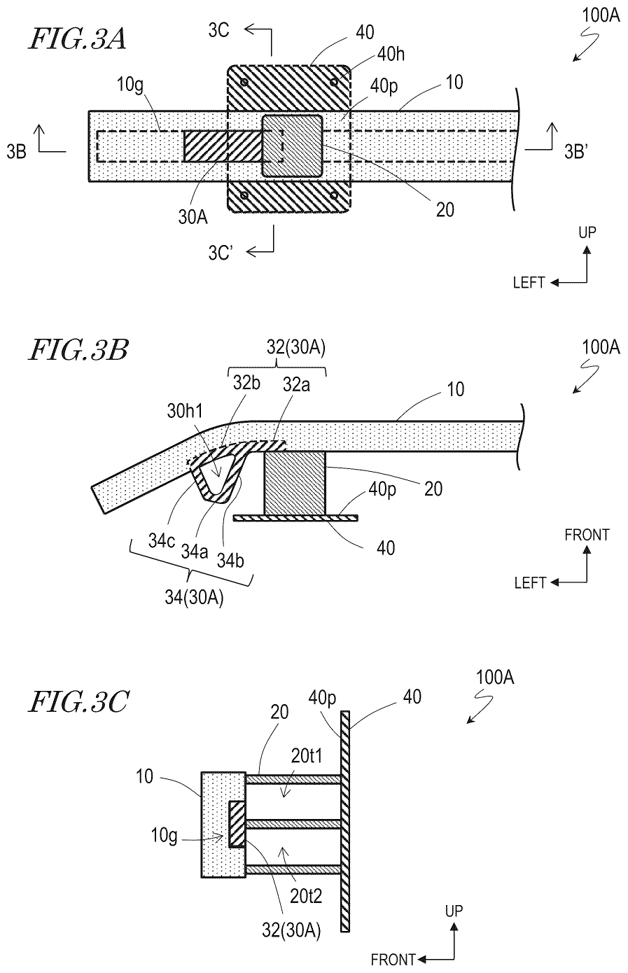

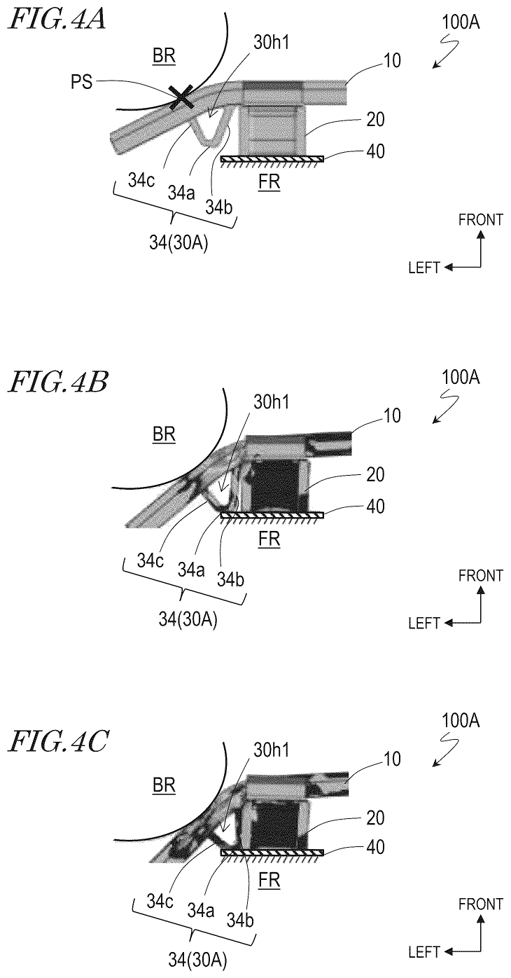

Now, with reference to FIG. 2, FIG. 3A, FIG. 3B and FIG. 3C, a configuration of a bumper assembly 100A according to an embodiment of the present invention will be described.

First, FIG. 2 will be referred to. FIG. 2 is a schematic exploded perspective view of the bumper assembly 100A. The bumper assembly 100A includes the beam 10, the energy absorption member 20, a load transmission member 30A, and the plate 40.

The energy absorption member 20 is joined with the plate 40, and the plate 40 includes a peripheral portion 40p extending in the vehicle width direction beyond the energy absorption member 20. In this embodiment, the peripheral portion 40p includes a portion extending also in an up-down direction beyond the energy absorption member 20. The plate 40 is joined with the frame of the vehicle (the frame FR in FIG. 1) by, for example, bolts and nuts through, for example, through-holes 40h provided in the peripheral portion 40p.

The energy absorption member 20 includes a plurality of cylindrical portions 20t1 and 20t2 extending in a front-rear direction of the vehicle. The load transmission member 30A has a through-hole 30h1 running throughout the vehicle in the up-down direction. The rear surface of the beam 10 has a groove-like recessed portion 10g extending in the vehicle width direction, and a portion of the load transmission member 30A is fitted into the recessed portion 10g.

Now, with reference to FIG. 3A; FIG. 3B and FIG. 3C, the configuration of the bumper assembly 100A will be described in more detail. FIG. 3A is a schematic rear view of the bumper assembly 100A. FIG. 3B is a schematic cross-sectional view of the bumper assembly 100A taken along line 3B-3B′ in FIG. 3A. FIG. 3C is a schematic cross-sectional view of the bumper assembly 100A taken along line 3C-3C′ in FIG. 3A. In FIG. 3A, a portion concealed by the plate 40 is shown as if the plate 40 was not present. That is, the energy absorption member 20, the load transmission member 30A and the beam 10, which are provided in this order from the side of a viewer of FIG. 3A, are shown.

As shown in FIG. 3B, the load transmission member 30A included in the bumper assembly 100A includes a plate-like portion 32 extending along the beam 10 in a cross-section parallel to a horizontal plane and including a flat plate portion 32a overlapping at least a portion of the energy absorption member 20 in the vehicle width direction, and also includes a protrusion portion 34 protruding from the plate-like portion 32 into a space between the rear surface of the beam 10 and the energy absorption member 20. In this embodiment, the protrusion portion 34 is located in a space defined by the rear surface of the beam 10, the energy absorption member 20 and a plane extending from the plate 40. The protrusion portion 34 includes a first portion 34a, a second portion 34b and a third portion 34c, and forms the through-hole 30h1 together with a portion 32b of the plate-like portion 32. As described below with reference to FIG. 4A through FIG. 4E, the load transmission member 30A including the first portion 34a, the second portion 34b and the third portion 34c may transmit a collision load caused in the SOT to the frame FR of the vehicle body efficiently.

The rear surface of the beam 10 has the groove-like recessed portion 10g extending in the vehicle width direction. The plate-like portion 32 of the load transmission member 30A is fitted into the recessed portion 10g. In this case, the plate-like portion 32 is flush with the beam 10. The plate-like portion 32 is fitted into the recessed portion 10g of the rear surface of the beam 10, so that the energy absorption member 20 may be increased in the length in the front-rear direction by a thickness of the plate-like portion 32. Therefore, the amount of energy absorbable by the energy absorption member 20 may be increased. Oppositely, in the case where the amount of energy to be absorbed by the energy absorption member 20 is kept the same, the overall length of the vehicle in the front-rear direction may be shortened.

As shown in this embodiment, it is preferred that the energy absorption member 20 includes the plurality of cylindrical portions 20t1 and 20t2 extending in the front-rear direction of the vehicle. The plurality of cylindrical portions 20t1 and 20t2 are arranged in the up-down direction, but may be arranged in the vehicle width direction, instead. Alternatively, the energy absorption member 20 may include three or more cylindrical portions arranged in the up-down direction and/or in the vehicle width direction. Walls forming the plurality of cylindrical portions 20t1 and 20t2 are deformed, and as a result, the energy absorption member 20 absorbs the energy,

Now, with reference to FIG. 4A through FIG. 4E, it will be explained that the load transmission member 30A included in the bumper assembly 100A may transmit the load to the frame FR of the vehicle body efficiently in the SOT. FIG. 4A through FIG. 4E show a change in the shape of the bumper assembly 100A in the SOT. FIG. 4A through FIG. 4E each show a shape of the bumper assembly 100A obtained by a collision simulation performed by the finite element method. For the simulation, general-purpose finite element analysis software RADIOSS (registered trademark) was used.

FIG. 4A is a schematic plan view showing the positional relationship between the barrier BR and the bumper assembly 100A at the instance of collision in the SOT, and shows a position, in the beam 10, against which the barrier BR collides (point PS). FIG. 4B through FIG. 4E are respectively schematic plan views showing the shapes of the bumper assembly 100A in an early period, an early middle period, a late middle period, and a late period of the collision in the SOT.

As shown in FIG. 4B, when the beam 10 is deformed in the early period of the collision, the load transmission member 30A moves obliquely rearward, and as a result, the load is transmitted rearward to the energy absorption member 20 from a portion, of the load transmission member 30A, that overlaps the energy absorption member 20 (from the plate-like portion 32). In addition, the first portion 34a of the protrusion portion 34 of the load transmission member 30A contacts the peripheral portion of the plate 40, and as a result, the load is transmitted to the frame FR via the protrusion portion 34. At this point also, the load transmitted rearward to the energy absorption member 20 from the plate-like portion 32 overlapping the energy absorption member 20. A portion of the energy absorption member 20 (an upper left corner in FIG. 4B) is crushed by the load transmitted rearward from the plate-like portion 32.

As shown in FIG. 4C, in the early middle period of the collision, the second portion 34b of the protrusion portion 34 contacts a side surface, of the energy absorption member 20, that is perpendicular to the plate 40. In the case where the angle made by the first portion 34a and the second portion 34b of the protrusion portion 34 is substantially equal to the angle made by the side surface of the energy absorption member 20 and the peripheral portion of the plate 40 (in this embodiment, 90 degrees), the above-described relationship is provided. The third portion 34c of the protrusion portion 34 becomes generally parallel to a line connecting the position PS, in the beam 10, against which the barrier BR collides and an intersection of the plate 40 and the side surface of the energy absorption member 20. At this point also, the load is transmitted rearward to the energy absorption member 20 from the plate-like portion 32 overlapping the energy absorption member 20.

As described above, in the process from FIG. 4A through FIG. 4C, the load is transmitted from the load transmission member 30A to the frame FR of the vehicle body efficiently. As long as including at least the flat plate portion 32a overlapping a portion of the energy absorption member 20 in the vehicle width direction, the load transmission member 30A may transmit the load effectively to the frame FR of the vehicle body via the energy absorption member 20. Needless to say, it is preferred that the protrusion portion 34 includes the first portion 34a, the second portion 34b and the third portion 34c as described above. Alternatively, the protrusion portion 34 may include only one of, or two of, the first portion 34a, the second portion 34b and the third portion 34c.

As shown in FIG. 4C through FIG. 4E, the through-hole 30h1 formed by the protrusion portion 34 and the portion 32b (see FIG. 3B) of the plate-like portion 32 is crushed. As can be seen from this, also in the process in which the load transmission member 30A is deformed, the flat plate portion 32a overlapping a portion of the energy absorption member 20 keeps on moving rearward, and as a result, the load is transmitted rearward to the energy absorption member 20 from the plate-like portion 32.

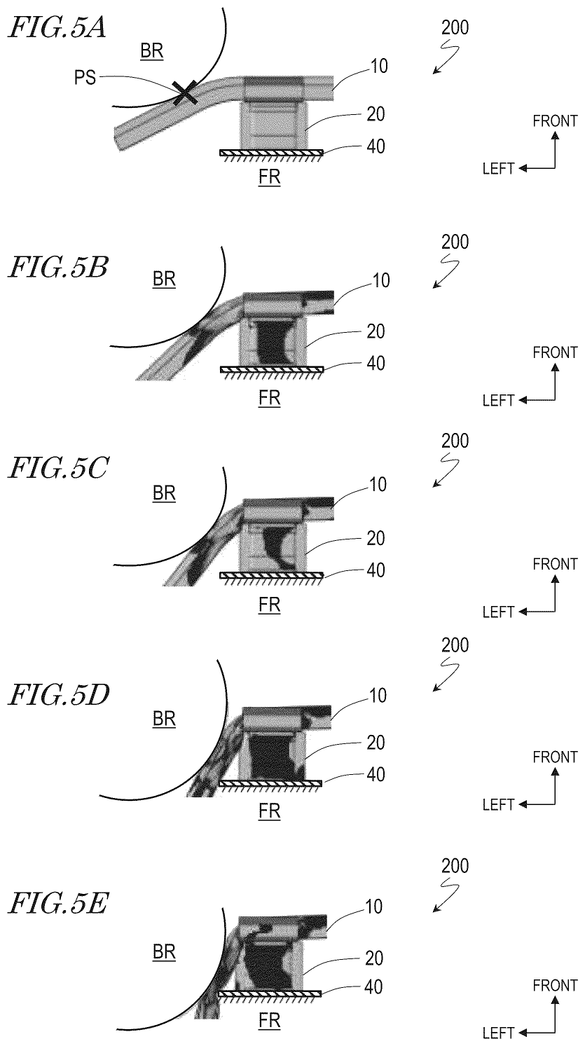

FIG. 5A through FIG. 5E show a change in the shape of a bumper assembly 200 in a comparative example in the SOT. The bumper assembly 200 does not include the load transmission member 30A, which is included in the bumper assembly 100A. FIG. 5A is a schematic plan view showing the positional relationship between the barrier BR and the bumper assembly 200 at the instance of collision in the SOT, and shows a position, in the beam 10, against which the barrier BR collides (point PS). FIG. 5B through FIG. 5E are respectively schematic plan views showing the shapes of the bumper assembly 200 in an early period, an early middle period, a late middle period, and a late period of the collision in the SOT.

With the bumper assembly 200, as can be seen from, for example, FIG. 5E, the beam 10 may undesirably be broken at a joining portion thereof with the energy absorption member 20 in the late period of the collision. By contrast, with the bumper assembly 100A, as can be seen from, for example, FIG. 4E, the load transmission member 30A extends outward in the vehicle width direction beyond a portion, of the plate-like portion 32, overlapping the energy absorption member 20, and thus, a rapid change in the rigidity of the bumper assembly 100A in the vehicle width direction may be suppressed. Therefore, the beam 10 may be prevented from being broken at a joining portion thereof with the energy absorption member 20.

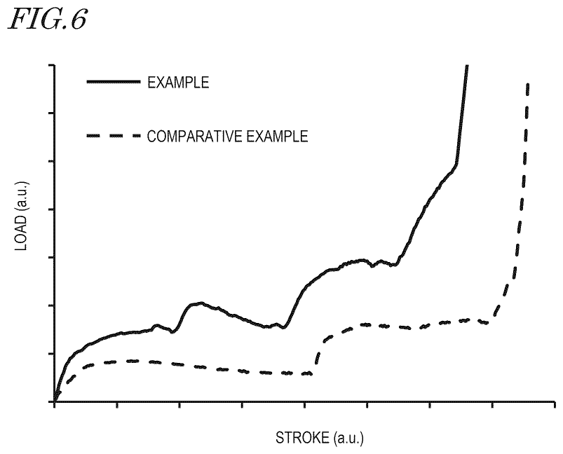

FIG. 6 is a load-stroke diagram showing the load transmitted by the bumper assembly to the frame structure of the vehicle body (in this embodiment, the frame FR) in the SOT. The horizontal axis representing the “stroke” shows the position to which the barrier invades along with the time of the collision. The vertical axis representing the “load” shows the reaction force of the frame FR. As can be seen from FIG. 6, the bumper assembly 100A according to the example transmits the load rearward more efficiently than the bumper assembly 200 in the comparative example.

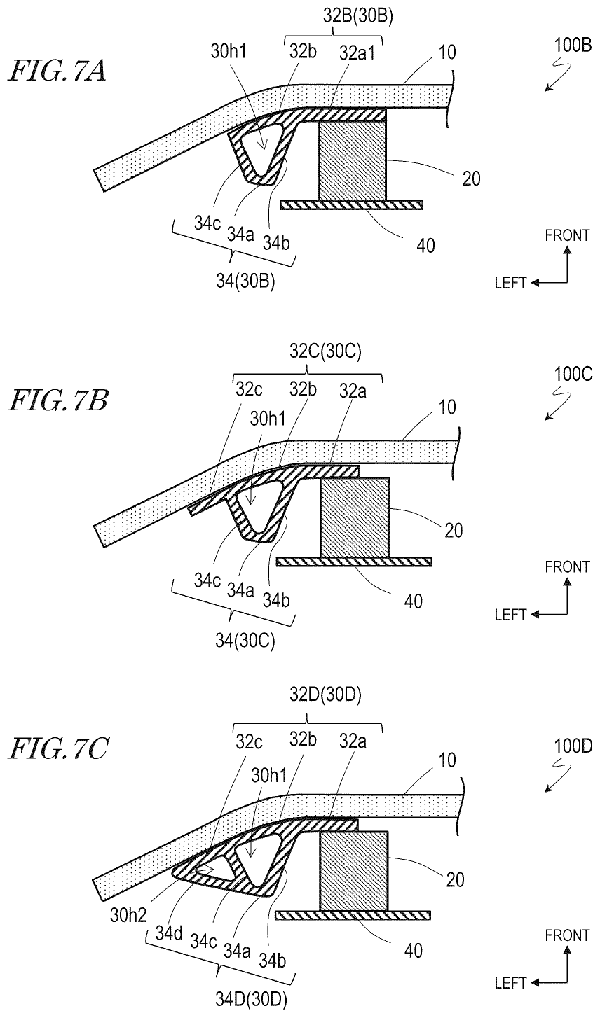

The load transmission member included in the bumper assembly according to an embodiment of the present invention may be modified in any of various manners. FIG. 7A, FIG. 7B and FIG. 7C are respectively schematic cross-sectional views of other bumper assemblies 100B, 100C and 100D according to embodiments of the present invention.

A load transmission member 30B included in the bumper assembly 100B shown in FIG. 7A includes a plate-like portion 32B including a flat plate portion 32al and also includes the protrusion portion 34. The protrusion portion 34 is the same as the protrusion portion 34 included in the load transmission member 30A of the bumper assembly 100A. The load transmission member 30B is different from the load transmission member 30A in that the flat plate portion 32al included in the plate-like portion 32B overlaps the entirety of the energy absorption member 20 in the vehicle width direction. The plate-like portion 32B includes the flat plate portion 32al overlapping the entirety of the energy absorption member 20 as described above, so that the load transmission member 30B may transmit the load to the frame FR of the vehicle body efficiently.

A load transmission member 30C included in the bumper assembly 100C shown in FIG. 7B includes a plate-like portion 32C and the protrusion portion 34. The protrusion portion 34 is the same as the protrusion portion 34 included in the load transmission member 30A of the bumper assembly 100A. The load transmission member 30C is different from the load transmission member 30A in that the plate-like portion 32C includes a portion 32c extending outward in the vehicle width direction beyond the third portion 34c. The plate-like portion 32C includes the portion 32c, and therefore, the joining portion of the plate-like portion 32C with the beam 10 may be extended outward in the vehicle width direction. In addition, even if the barrier BR is shifted outward in the vehicle width direction at the time of the collision, the load may be transmitted to the frame FR of the vehicle body efficiently.

A load transmission member 30D included in the bumper assembly 100D shown in FIG. 7C includes a plate-like portion 32D and a protrusion portion 34D. The load transmission member 30D is different from the load transmission member 30A in that the plate-like portion 32D includes the portion 32c extending outward in the vehicle width direction beyond the third portion 34c and that the protrusion portion 34D includes a fourth portion 34d forming a through-hole 30h2 together with the portion 32c and the third portion 34c. The load transmission member 30D may transmit the energy to the energy absorption member 20 more efficiently than the load transmission member 30A and also may absorb the energy.

### (Production Method)

The beam may be formed of, for example, a 6000-series (Al—Mg—Si-based) or 7000-series (Al—Zn—Mg-based) aluminum alloy by extrusion molding. The energy absorption member may be formed of, for example, a 6000-series aluminum alloy by extrusion molding. The load transmission member may be formed of, for example, a 6000-series aluminum alloy by extrusion molding. The plate may be formed of, for example, a 5000-series (Al—Mg-based) or 6000-series aluminum alloy by extrusion molding and rolling.

### INDUSTRIAL APPLICABILITY

The bumper assembly according to an embodiment of the present invention may improve the safety in the SOT.

### REFERENCE SIGNS LIST

10: beam; 10g: recessed portion (groove); 20: energy absorption member; 30, 30A: load transmission member; 40: plate; 40p: peripheral portion; 40h: through-hole; 20t1, 20t2: cylindrical portion

1. A bumper assembly attachable to a front portion of a vehicle, the bumper assembly comprising, in a state of being attached to the vehicle:
a beam extending in a vehicle width direction;
an energy absorption member (stay) partially joined with a rear surface of the beam; and
a load transmission member located between a position, in the beam, against which a barrier is to collide in an SOT (small overlap test) and the energy absorption member, and joined with the rear surface of the beam so as to overlap at least a portion of the energy absorption member in the vehicle width direction.

2. The bumper assembly of claim 1, wherein in a state of being attached to the vehicle, the load transmission member comprises:
a plate-like portion extending along the beam in a cross-section parallel to a horizontal plane and including a flat plate portion overlapping at least a portion of the energy absorption member in the vehicle width direction, and
a protrusion portion protruding from the plate-like portion into a space between the rear surface of the beam and the energy absorption member.

3. The bumper assembly of claim 2, further comprising a plate to be joined with a frame of the vehicle, wherein:
the energy absorption member is joined with the plate,
the plate comprises a peripheral portion extending in the vehicle width direction beyond the energy absorption member, and
in a state of being attached to the vehicle, the protrusion portion of the load transmission member is located in a space defined by the rear surface of the beam, the energy absorption member and a plane extending from the plate, in a cross-section parallel to the horizontal plane.

4. The bumper assembly of claim 3, wherein the protrusion portion comprises a first portion contacting the peripheral portion of the plate in the SOT.

5. The bumper assembly of claim 4, wherein the protrusion portion comprises a second portion contacting, in the SOT, a side surface of the energy absorption member, the side surface being perpendicular to the plate.

6. The bumper assembly of claim 5, wherein the protrusion portion comprises a third portion that, in the SOT, becomes generally parallel to a line connecting the position, in the beam, against which the barrier is to collide and an intersection of the plate and the side surface of the energy absorption member, the third portion becoming generally parallel to the line in the cross-section parallel to the horizontal plane.

7. The bumper assembly of claim 2, wherein:
the rear surface of the beam has a recessed portion, and
the plate-like portion of the load transmission member is fitted into the recessed portion.

8. The bumper assembly of claim 1, wherein the energy absorption member comprises a plurality of cylindrical portions extending in a front-rear direction of the vehicle.
